(19) United States
(12) Patent Application Publication
(10) Pub. No.: US 2009/0207699 A1
(43) Pub. Date: Aug. 20, 2009

(54) TIMEPIECE, ESPECIALLY WRISTWATCH COMPRISING A MAIN DISPLAY AND A MECHANISM ACTUATING AT LEAST ONE SECONDARY DISPLAY

(76) Inventors: Mathias Buttet, Divonne Les Bains (FR); Enrico Barbasini, Ambilly (FR); Michel Navas, Collonges (FR)

Correspondence Address: OSTROLENK FABER GERB & SOFFEN, 1180 AVENUE OF THE AMERICAS, NEW YORK, NY, 100368403, US

(21) Appl. No.: 11/719,167

(22) PCT Filed: Nov. 12, 2004
(86) PCT No.: PCT/EP2004/012865

§ 371 Date: Feb. 18, 2009

(51) Int. Cl. G04B 19/23

(52) U.S. Cl. 368/21

(57) ABSTRACT

The mechanism is driven by the hour wheel of the timepiece and has at least one secondary display comprising a polygonal or round hand or indicator rotating around a track of the secondary display and indicating on its visible surface names of cities or countries separated according to their respective time zones, the names of cities or countries being marked around the circumference of the hand or indicator opposite the hours on the track.

The object of the invention is a timepiece, especially a wristwatch comprising a main display designed to display the local time and a mechanism actuating at least one secondary display equipped with a hand or indicator designed to display a chosen time zone, the mechanism being driven by the movement of the timepiece.

There exist a multitude of timepieces with different indications of one or more time zones. The simplest consists in placing at least two separate movements in the same watch in order to display two different times. The most complicated, the “town watch”, which can be used firstly to determine the name of a town and secondly to read the time in this town in relation to the time in a chosen geographical position, is perfectly familiar to the professional.

The drawback of the simplest system is that there is no mechanical connection enabling a given difference to be retained when one of the movements is set to the right time. The drawback of the most sophisticated systems known at present is that they are too complex and much too costly for simply indicating one or more time zones.

The purpose of this invention is to eliminate these drawbacks and produce a timepiece or wristwatch which is most similar to a timepiece showing a universal time which can give the time in a large number of towns located in different time zones, without using for that purpose systems or mechanisms which are too numerous or too complex.

The timepiece according to the invention is characterised in that the secondary display of the mechanism presents a hand or indicator of polygonal or rounded shape rotating around a track of the secondary display indicating the times and carrying names of towns or countries with time differences according to their respective time zones, the names of towns and countries being marked on the perimeter of the hand or indicator opposite the hours of the track.

According to a preferred mode of execution, the mechanism comprises several secondary displays or counters linked to each other and distributed on the perimeter of the dial of the timepiece, the respective positions of the hands or indicators (7-9; 42-45) being chosen, mounted and indexed at the time of assembly of the mechanism or of casing of the timepiece. The track of the secondary displays is preferably a 24-hour track and a setting wheel is inserted between the hour wheel of the timepiece and a mobile of the mechanism making one rotation in 24 hours and supporting the indicator of the display or counter.

The tracks of the displays or counters preferably present a day area and a night area if the track is a 24-hour track.

The hands or indicators are supported by gear trains of the mechanism linked and indexed to each other by linking mobiles. One of the indicators of the mechanism will be attached on an indexed gear train supporting a counter and designed to be able to be moved in jumps of 1 hour in relation to a 24-tooth star positioned precisely by a ratchet placed on a jumper. Lastly, the 24-tooth star mounted on the wheel of the display or counter can be controlled by a mobile via a setting wheel linked to the winding mechanism of the timepiece to make a time setting or a correction of the indication of all the displays or counters with respect to the local time in the geographical position in which the timepiece is worn.

The drawing represents as an example a mode of execution and a variant of a timepiece comprising a mechanism with multiple time zones or universal time according to the invention.

In the drawing:

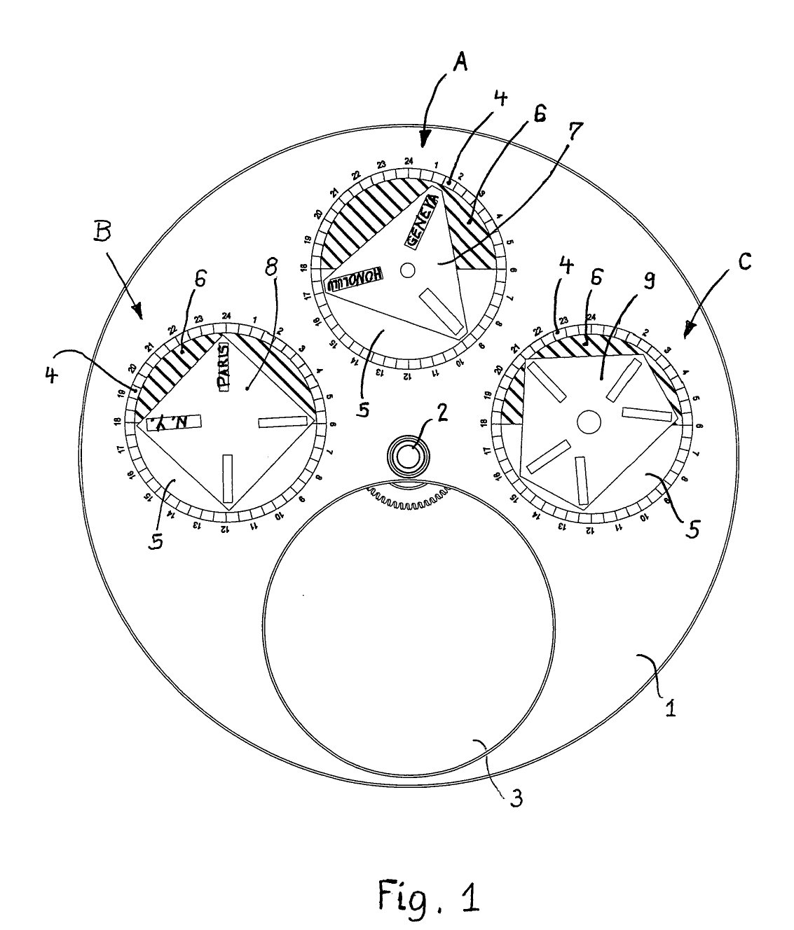

FIG. 1 is a schematic top view, on the dial side, of the mode of execution of the timepiece,

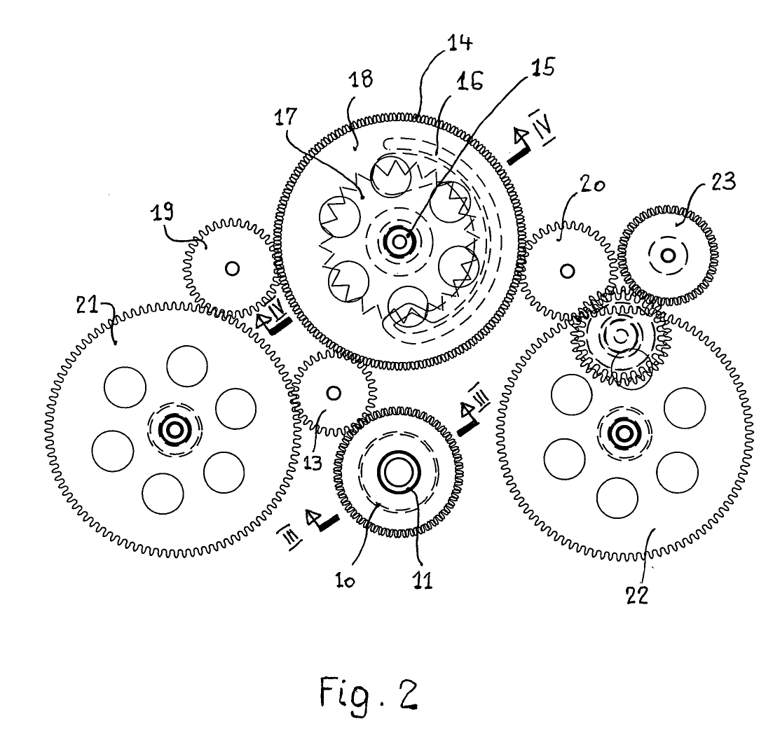

FIG. 2 is a view of the mechanism enabling the display of the various time zones of the timepiece of the mode of execution shown in FIG. 1,

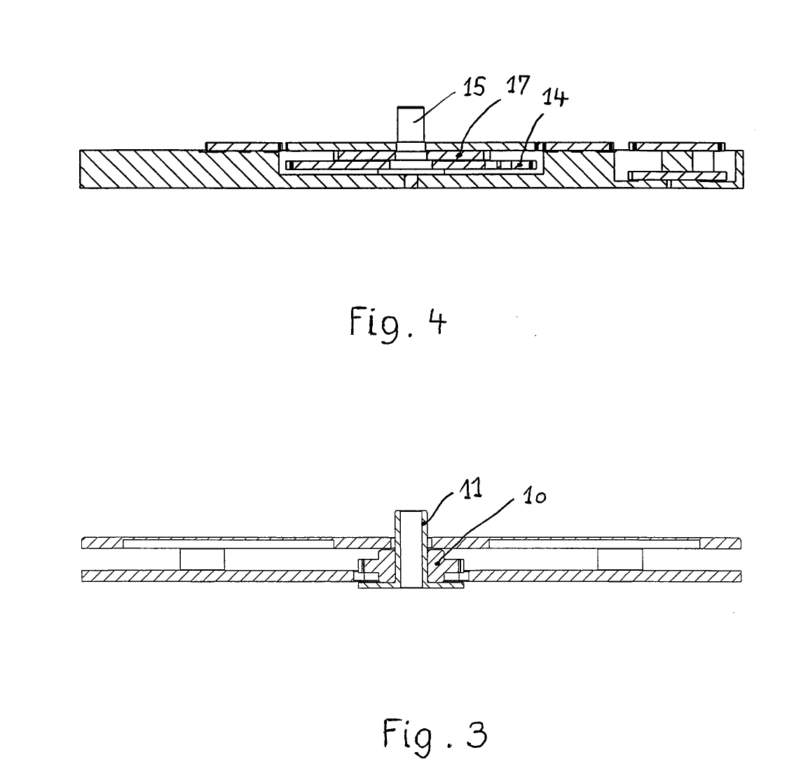

FIG. 3 is a cross section along the line III-III in FIG. 2,

FIG. 4 is a cross section along the line IV-IV in FIG. 2, and

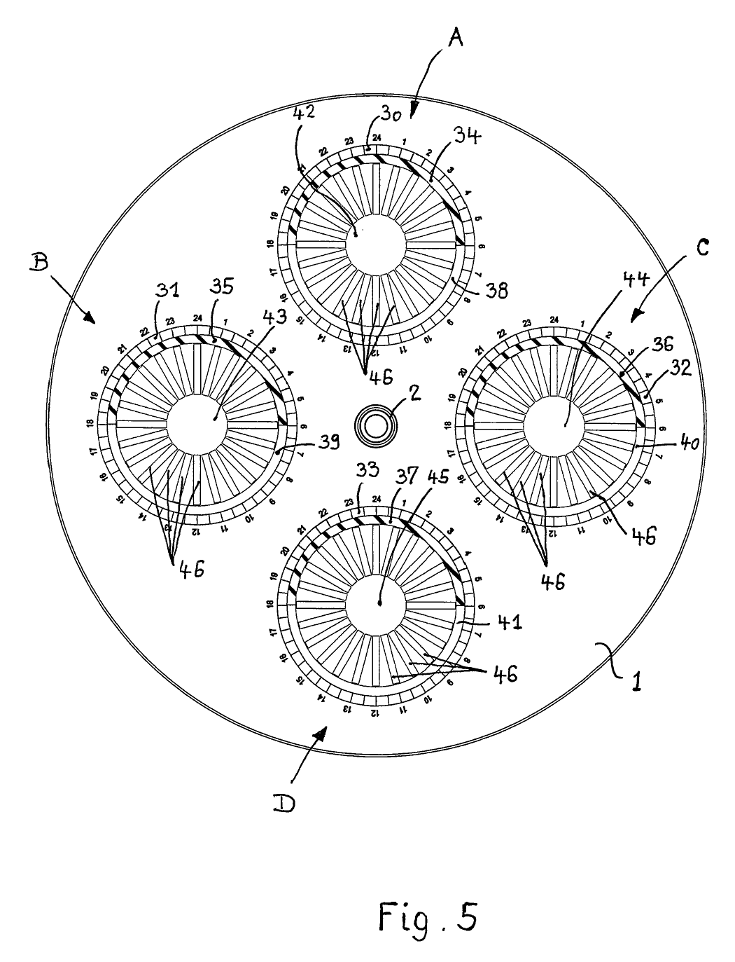

FIG. 5 is a schematic top view, on the dial side, of the mode of execution of the timepiece in FIG. 1.

The timepiece represented in the drawing was designed as a wristwatch. This use is not limitative, however, and the timepiece can be produced as a pocket match or even as a small clock.

In addition, the timepiece according to the invention will present, in addition to the main display indicating the local time, several secondary display areas for different time zones enabling indication of the time at least in one town located in another time zone and at most in some fifty or more towns located in different time zones in the world.

As shown in FIG. 1, the dial (1) of the timepiece comprises a counter or display (A) positioned at 12 o'clock with respect to the main display indicating the local time by means of the hour and minute hands (not shown) attached on the central spindle (2) of the timepiece. A display or counter (B), or respectively (C), is positioned at 9 o'clock, or respectively 3 o'clock, on the dial (1) and at the bottom of the dial there is an opening (3) enabling presentation of the balance or the tourbillon of the movement of the timepiece or any other element required to be shown or displayed.

The displays or counters (A, B and C) each present a 24-hour track (4) with two areas (5 and 6) indicating day and night respectively.

The key idea of the counters (A, B and C) of the invention lies in their display. The conventional hand of a 24-hour or time zone indicator is replaced in the mode of execution shown in FIG. 1 by a hand or indicator representing a variable geometrical figure, in particular a triangle (7) for the counter (A), a square (8) for the counter (B) and a pentagon (9) for the counter or display (C).

In the mode of execution shown in FIG. 1, the three hands (7, 8 and 9) present the following particularities:
The display or counter (A) positioned at 12 o'clock on the dial (1) comprising a hand in the form of a triangle carries the names of 3 towns which each have an 8-hour time difference between them.
It will be understood that when the time in Paris for example is changed by 2 hours, Honolulu is also corrected by the same period of time, the difference between these towns being constant.
In the case of the display or counter (B), with a square-shaped hand or indicator (8), the names of four towns which each have a 6-hour time difference between them are marked, Paris and New York for example being two of the towns.
In the case of the display or counter (C), the polygonal indicator (8) enables the display of five towns presenting different time differences. It is obvious for the professional that the choice of the towns to be displayed with their time difference will determine the polygonal shape of the hand or indicator (9). In a variant, the polygonal counter or display (C) may be a regular hexagon with a time difference of 4 hours between each town displayed or indicated.
The time difference between the 1^{st}, 2^{nd} and 3^{rd} display or counter (A, B and C) is decided at the time of casing of the hands or indicators (7, 8 and 9) in accordance with the wishes of the wearer of the watch, the chosen towns or countries and the place in which the watch is to be sold.

In the mode of execution shown in FIG. 1 which has just been described, it will be possible to know at a glance the time in twelve different towns in the world, in addition to the local time indicated by the hands attached on the central spindle (2) of the main display.

The mechanism controlling the counters or displays (A, B and C) of the timepiece represented in FIG. 1 is illustrated in FIGS. 2, 3 and 4. As shown, the setting wheel (10) solidly attached on the hour wheel (11) making one rotation in 12 hours drives the mobile (13) which drives the 24-hour wheel (14) pivoting freely on the spindle (15). The jumper (16) (FIG. 2) solidly attached on the 24-hour wheel (15) drives the 24-hour star (17) solidly attached on the spindle (15). The wheel (18) carrying the display or counter (A), attached on the spindle (15), is thus driven and the setting wheels (19 and 20) drive the 24-hour wheels (21 and 22) of the displays or counters (B and C) at a speed identical to that of the wheel (18), i.e. one rotation every 24 hours.

On the spindles of the wheels (18, 21 and 22) will be placed the hands or indicators (7, 8 and 9) of the counters or displays (A), or respectively (B) and (C).

By means of the setting wheel (23) it is possible to make a correction of the indication of the mechanism's time zone counters (A) (FIG. 1), or respectively B and C. This mobile (23) receives a rotation movement from any basic movement of the timepiece via the winding stem (not shown) of this basic movement.

As the object of the patent is an additional module, this part of the adjustment of the mechanism which has just been described, with which the professional is familiar, will not be specified.

In a variant, it is also possible to actuate the mobile (23) independently from a conventional system for setting to the right time. It may for example be actuated by a push button located on the outside of the case (like a conventional corrector). However, the drive mode of the mobile (23) is unimportant. It is via this mobile that the information for incrementing or indexing of the counters or displays (A, B and C) arrives.

FIG. 2 shows a cross section of a conventional display or counter (A, B or C), in which a hand or indicator (7, 8 and 9) is driven. In our invention, this hand may take the form of a regular or irregular polygon and indicates the value of the time zones in an analogue manner. It may also be round in shape as shown later in FIG. 5.

When the winding stem of the basic movement or of the timepiece is in the locked position, the time of the geographical place which passes drives, in our case, the top counter (A) which meshes with the other two (B and C) (FIG. 1).

On setting to the right time, the counter (A) disengages from its indication to enable variation of the difference between the local time and the time in the time zones of the towns indicated. As shown in FIG. 2, the counters (B and C) supported by the wheels (21 and 22) mesh with the counter (A) carried by the wheel (18), the three wheels (18, 21 and 22) being attached to each other and linked by the setting wheels (19 and 20). Thus the counters (A, B and C) are indexed with respect to the local time and the indexing is determined on assembly of the mechanism and the time difference between the displays or counters (A, B and C), together with the marking of the towns on the counters, is decided at the time of casing of the mechanism or of the timepiece in the operation of setting of the indicators (7, 8 and 9) (FIG. 1) in accordance with the wishes of the wearer of the watch and the place in which it is to be sold and worn.

All of the displays or counters (A, B and C) can be set to the right time in accordance with the local time indicated by the spindle (2) by means of the winding stem which will allow the mobile (23) to be actuated (FIG. 2).

The 24-hour star (17) and the jumper (16) on the wheel (18) of the counter (A) allow correction of the difference between the local time and the time in one of the towns indicated by the hands (7, 8 and 9). Without this star and this jumper, the directions of rotation of the correction and of the functioning of the basic movement would be in opposition to each other and would damage the mechanism or the basic movement.

This jumper (16) and this 24-hour star (18) could be replaced mechanically by any type of friction, but the star (18) makes it possible to adjust the difference on 24ths of a rotation, i.e. exactly on the position of the hour.

FIG. 5 shows a variant of the mode of execution shown in FIG. 1 of a timepiece comprising a multiple time zone mechanism. In this mode of execution, the dial (1) of the timepiece presents a central display designed to display the local time by means of hands (not shown) mounted on the central spindle (2). In the variant illustrated in FIG. 5, four time zone displays or counters (A, B, C and D) are placed at the 12 o'clock, 9 o'clock, 3 o'clock and 6 o'clock positions respectively on the dial (1). The four displays or counters all present 24-hour tracks (30, 31, 32 and 33) together with the indication of night areas (34, 35, 36 and 37) and day areas (38, 39, 40 and 41). The hands or indicators (42, 43, 44 and 45) are circular in shape and present areas (46) on their circumference to mark towns or countries presenting time differences corresponding to their positions. In the variant shown in FIG. 5, there are four indicators (42 to 45) on each of which it is possible to mark 24 names of towns or countries, which allows 96 time zones to be indicated. Obviously, it is possible to restrict the number of time zones or to reserve for example a display or a counter for a few towns or countries on a continent.

1. Timepiece, in particular a wristwatch, comprising a main display designed to display the local time and a mechanism activating at least one secondary display fitted with a hand or indicator designed to display a chosen time zone, the mechanism being driven by the movement of the timepiece, wherein the secondary display of the mechanism has a polygonal or round hand or indicator rotating around a track of the secondary display indicating the hours and bearing names of cities or countries separated according to their respective time zones, the names of cities and countries being marked around the circumference of the hand or indicator opposite the hours on the track.

2. Timepiece in accordance with claim 1, wherein the mechanism comprises several secondary displays or counters linked to each other and distributed around the circumference of the dial of the timepiece, the respective positions of the hands or indicators being chosen, mounted and indexed at the time of assembly of the mechanism or casing of the timepiece.

3. Timepiece according to claim 2, the tracks of the secondary displays are 24-hour tracks and in that a setting wheel is inserted between the hour wheel of the timepiece and a mobile of the mechanism completing one rotation in 24 hours and holding the indicator of one of the displays or counters.

4. Timepiece according to claim 3, wherein the tracks of the displays or counters A, B, C and D have a day zone and a night zone.

5. Timepiece according to claim 2, wherein the hands or indicators of the mechanism are held by toothed wheels linked and indexed to each other by linking mobiles.

6. Timepiece according to claim 2, wherein one of the indicators fixed to an indexed toothed wheel of the mechanism holding the counter is arranged so that it can be moved in 1 hour jumps relative to a 24-hour star accurately positioned by a click placed on a jumper.

7. Timepiece according to claim 6, wherein the 24-tooth star mounted on the wheel of the display or counter is controlled by a mobile by means of a setting wheel connected to the winding mechanism of the timepiece to set or correct the indication of all of the displays or counters relative to the local time in the geographical location where the watch is worn.
